(19) United States
(12) Patent Application Publication
(10) Pub. No.: US 2023/0326325 A1
(43) Pub. Date: Oct. 12, 2023

(54) "Security system that notifies cell phone"

(71) Applicant: Edward Christian Bedford, Richmond, TX (US)

(72) Inventor: Edward Christian Bedford, Richmond, TX (US)

(21) Appl. No.: 16/873,601

(22) Filed: May 18, 2020

(51) Int. Cl. G08B 25/01; G08B 13/22

(52) U.S. Cl. CPC G08B 25/014; G08B 13/22

(57) ABSTRACT

Cell Secure Phone is a newly invented security system for vehicles designed to identify and photograph a vehicle intruder or thief. The system is paired with a software application, allowing an in-vehicle camera to take a photograph of the thief and automatically send the photo to the software application for immediate identification

The ‘Cell Secure Phone’ main body part was constructed by plastic molding injection method. In other words, plastic pellets are heated to high temperature where it becomes molten liquid at a superheated temperature. The liquefied plastic is poured into special made prefab, forged cast iron which is in the shape preferred to form the casing and the cover that will carry the electronic equipment to protect the integrity of the equipment. The nature of the built is tough to resist easy breakage because of the plastic material used for durability and longevity.

In my research investigation, it was established that there are some similarities between ‘Cell Secure Phone’ invention and the references made in QIAHE and BECKER. The main differences with Qiahe are that (i) My Invention do not use GPS to locate stolen cars. It actually prevents the car from being driven away or far from the original parking spot. (ii) With ‘Cell Secure System’, the Alarm does not go off when the door entry point is breached but the alarm goes off only when the thief sit behind the steering wheel in an attempt to steal and drive away. (iii) Becker's inventions are more related historically to inventions in the early twentieth century but technology has since moved on.

Overall we conclude that “Cell Secure Phone” will reduce or eradicate car thefts and protect motorist and assure them that their vehicles that are safely parked anywhere and everywhere will not experience any case of theft. This will also protect the auto insurance industry to prevent potential financial loses as result of payment or replacement to owners. This will ultimately increase the productivity and profitability of the auto insurance and vehicle manufacturing industry and boost the improvement of the industry.

### III. SPECIFICATION

### 1. Background of the Invention

The Name of the Invention is called CELL SECURE. This Project was invented by Edward Christian Bedford, a Marine Engineer and Businessman by Profession at Houston, Texas.

The Inventor and Owner of the ‘Cell Secure’ sort for a paid service from Davison Invention Inc of Pennsylvania, in United States who completed the project with a built prototype of ‘Cell Secure’ in 2013.

“Cell Secure” Invention Is ‘A Security System that Notifies Cell Phone etc including Ipod, laptop and others that an intruder has broken into the car, house, office and other secured facility’. The picture of the intruder or burglar will show on the cell phone of the car owner and be saved. Both the car engine and car doors are then locked by the owner of the car from a distant with the cell phone and photo of the intruder already saved on the car owner's cell phone is further handed over to the police.

The Inventor and Owner of ‘Cell Secure’ Invention has already acquired Provisional—Certification of Micro Entity Status and wants an upgrade to Non-provisional Utility Patent

In the case of any future improvement, CELL SECURE can be adopted to protect entry point door of private yacht, planes and other high scale and sensitive items and properties.

The idea of such invention came about as a result of enormous level of auto-theft existing in almost every State and County in the United State and most of the stolen cars are not retrieved back. They are either split into spare part or sold. Most of the cars are shipped abroad and sold. Resulting in huge loses for auto insurance companies and cause increase in rate for policy holders. Therefore this invention of the “Cell Secure” will help to eradicate car burglaries in America and other part of the world

### 2. Brief Summary of the Invention

The purpose of the ‘Cell Secure” invention is to stop car thieves in the tracks from burglary before they got away with another car.

Experience and research investigation report as shown by several data that car break-ins and car stealing activities have increase across United States and other parts of the globe, costing the car insurance industry and tax payers, multi-million dollars due to loses and there is no sign of stopping the trend of car burglaries.

According to an article published in ‘The Daily News’ Paper of Galveston, Texas on Sunday, 27 Sep., 2015; Texas Auto Burglary and Theft Prevention Authority spent $68.6M hard funds to investigate auto theft between 2011-2015. This was just after “Cell Secure” had been invented in 2013 and I, the Inventor was looking for marketing partnership to obtain Non-Provisional Utility License to no avail. In addition to the amount mentioned above for auto crime prevention, Texas Association of Vehicle Theft estimated $55 million used for purposes other than fighting Auto Crime at the same period to create crime-free environment. I do not have the current statistics but it will prudent to suggest that like Galveston County, there are many Counties in United States suffering the same fate of Car Theft and Break-ins and this is one of the main reason for the invention of “Cell Secure”.

A brief summary of ‘Cell Secure’ Invention is defined as ‘Security System that notifies Cell Phones, including Ipad, laptop and other other social media tools that an intruder has broken into a car, a house, an office or secured property or facility’. A typical real life situation is the description of a car owner who has installed a ‘Cell Secure’ Phone Application or Electronics in the car. The car is parked at the car-park of a Mall whiles he/she is inside the Mall shopping. Then a car-intruder breaks into the car. Immediately, the cell phone alarm of the car owner will go off to alert the car owner that a break-in, into the car is in progress or the car has been broken into. The owner of the car who is far away in the Mall will then click his/her phone again on the app and will see on the phone screen the face of the intruder sitting behind the wheel. Then the car owner will click on the phone and save the photo of the thief. Then further click again and will lock the thief inside the car and also lock the car engine to prevent the thief from driving away. The car owner may have to wait for the police to arrive before unlocking the car.

### 3. BRIEF DESCRIPTION OF THE DRAWINGS

There is one set, made of three drawings attached to the application. They are Case, Cover, Combined Case and Cover.

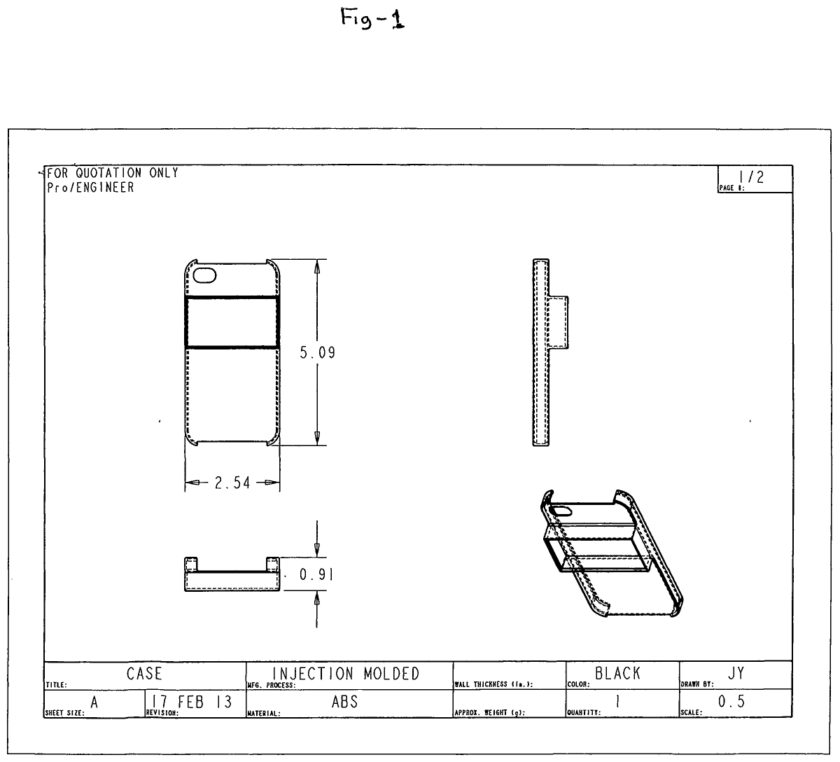

a) The Case Drawing Shows: “(FIG. 1)”

The Plan View; the Side View and the Top View

Dimension:
Length-5.09 cm: Width-2.54 cm: Thickness (0.91 cm).
Scale use for drawing: 0.5
Color: Black
Material Used: Synthetic Plastic Pellets
Method of Build: ABS Approved Plastic Injection Molding
Date Drawing Completed: 17 Feb. 2013

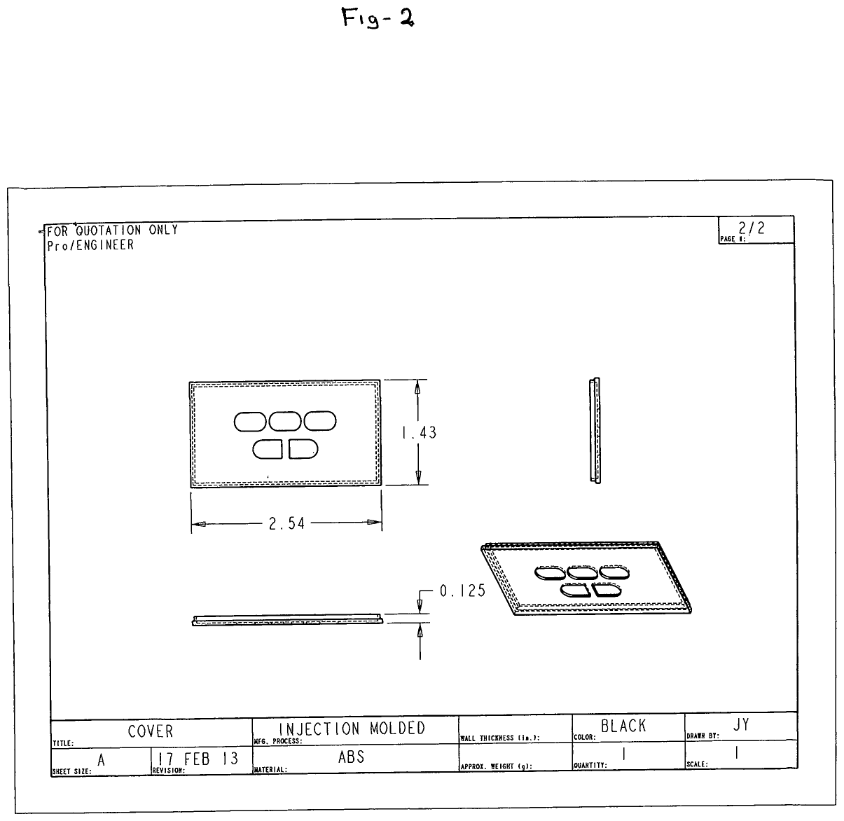

b) The Cover Drawing Shows: “(FIG. 2)”
The PlanView, the Side View and the Top View.

Dimension:

Length-1.43 cm: Width-2.54 cm: Thickness-0.125 cm.

Scale used for drawing: 1.0

Color: Black

Material Used: Synthetic Plastic Pellets.

Method of Build: ABS Approved Plastic Injection Molding.

Date Drawing Completed: 17 Feb. 2013

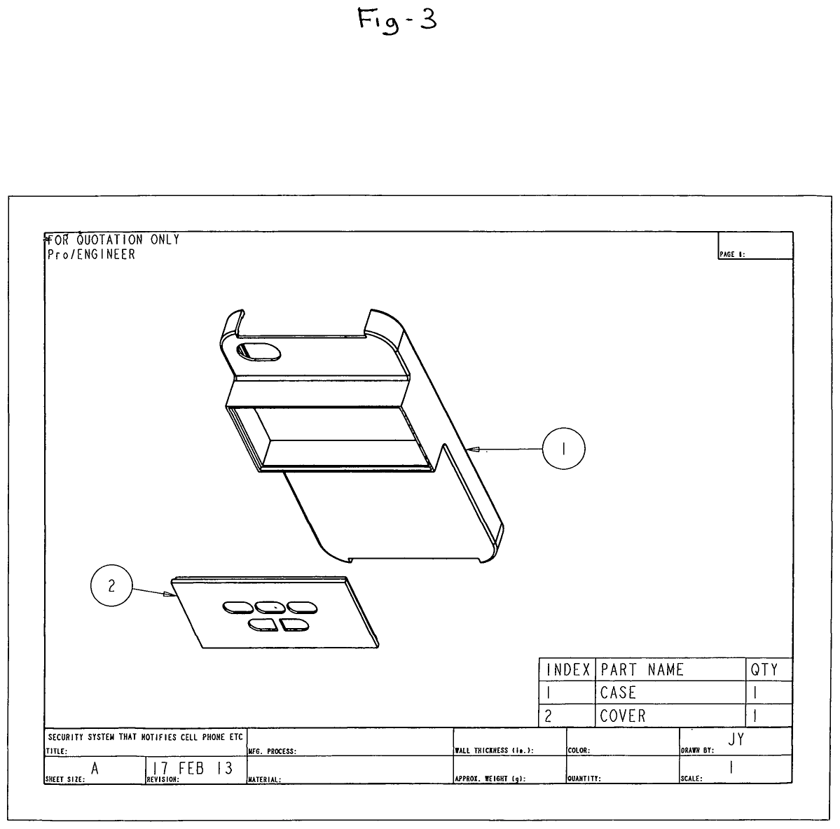

c) Joint Assembled Part of The Case and Cover Show: “(FIG. 3)”
Dimension:
(As Above)
Scale used for drawing: 1.0
Color: Black
Material Used: Synthetic Plastic Pellets
Method of Build: ABS Approved Plastic Injection Molding
Date Drawing Completed: 17 Feb. 2013

How Is This Made?
After many hours of design strategy process, a cost-effective and easy to manufacture product was finally designed. It consists of plastic injection molding, an ABS Cover and Case that carries the electronic part of the Assemble. A prototype product sample was built, tested and passed.

### 4. DETAILED DESCRIPTION OF INVENTION

The Catch Phrase of “Cell Secure” Invention is: ‘Do you fear you won't hear the alarm when someone is trying to break into your car?’

Experience has shown that traditional car alarms go off all the time and no one seem to hear or pay attention to them.

Getting a signal on a cell phone case from a car alarm that something sinister is going on is what ‘Cell Secure’ is all about. Hence ‘Cell Secure’ is the car security system with cell phone alert. Once the electronics is installed in your car, an alarm is triggered at any entry point, which sends a signal to your cell phone case. ‘Cell Secure’ has 125db siren as well as panic button and also features options for door lock/unlock and a remote starter. This accessory will keep your car secure everywhere and every time with ‘Cell Secure’.

In conclusion, A brief summary of ‘Cell Secure’ Invention is define as a ‘Security System that notifies Cell Phones, including Ipad, laptop and others that an intruder has broken into a car, a house, an office or secured property or facility’. For instant a typical real life situation will be a description of a car owner who having installed a ‘Cell Secure’ Phone Application or Electronics in the car. The car is parked at the car-park of a Mall whiles he/she is inside the Mall shopping. Then a car intruder breaks into the car. Immediately, the cell phone alarm of the car owner will go off to alert the car owner that a break-in into the car is in progress or the car has been broken into. The owner of the car who is far away in the Mall will then click on his/her phone again on the app and will see on the screen of cell phone the face of the intruder sitting behind the wheel. Then the car owner will click on the phone and save the photo of the thief. Furthermore, another click again will lock the thief inside the car and also lock the car engine to prevent the thief from driving away. The car owner may have to wait for the police to arrive before unlocking the car.

### DESCRIPTION OF PICTORIAL FIGURES ON THE BOX PACKAGE

The iconic photo on the package of CELL SECURE phone tool shows the photo of a lady staring closely to her cell phone whose alarm goes off. Whiles an intruder in a grey clothes attempt to break into a red car. The alarm alerted her that there was a break-in to her car and is in progress. She clicks on her phone once again and she finds the picture of the intruder wearing a hood and attempting to break into the red car, then sat behind her steering wheel. The car owner, then click the phone and save the picture of the thief to be handed to the police in case the thief manages to escape. Meanwhile the car owner finally click on an app on her cell phone to lock the thief inside the car from the distant to prevent the intruder from escaping and also locked the engine to stop the car to be driven away or the car engine from starting. The package box is what carries the electronic equipment, both the case and cover.

1. A method for protecting a vehicle, the method comprising the steps of:
installing a security system in the vehicle;
linking the security system to a mobile device;
receiving a notification to the mobile device when an unauthorized individual enters the vehicle;
uploading a picture of an interior of the vehicle and the unauthorized individual to the mobile device from the security system;
locking the vehicle remotely via the mobile device;
disabling the vehicle remotely via the mobile device; and
notifying a police agency of an attempted vehicle theft.
